(19) United States
(12) Patent Application Publication
(10) Pub. No.: US 2024/0419959 A1
(43) Pub. Date: Dec. 19, 2024

(54) LEARNING METHOD AND LEARNING DEVICE FOR TRAINING MULTI-TASKING NETWORK THAT PERFORMS MULTI-TASKS BY USING DATASETS HAVING DIFFERENT TASK LABELS AND TESTING METHOD AND TESTING DEVICE USING THE SAME

(71) Applicant: Deeping Source Inc., Seoul (KR)

(72) Inventor: Federica Spinola, Seoul (KR)

(21) Appl. No.: 18/209,287

(22) Filed: Jun. 13, 2023

(51) Int. Cl. G06N 3/08

(52) U.S. Cl. CPC G06N 3/08

(57) ABSTRACT

There is provided a method for training a multi-tasking network performing multi-tasks by using datasets having different task labels. In response to acquiring specific training data from main dataset including 1-st sub dataset having 1-st task label to n-th sub dataset having n-th task label, a learning device inputs the specific training data into a 1-st multi-tasking network to an n-th multi-tasking network, to thereby instruct the 1-st multi-tasking network to the n-th multi-tasking network to perform learning operation on the specific training data and to output n task results; calculates a 1-st task loss to an n-th task loss by referring to 1-st specific task result to n-th specific task result; calculates a 1-st unlabeled consistency loss group to an n-th unlabeled consistency loss group; and trains the 1-st multi-tasking network to the n-th multi-tasking network by using a total task loss and a total consistency loss.

### FIELD OF THE DISCLOSURE

The present invention relates to a method for training a multi-tasking network that performs multi-tasks, and more specifically, relates to the method for training the multi-tasking network that performs the multi-tasks by using each of datasets having each of task labels corresponding to each of different tasks and the learning device using the same, and the testing method for a trained multi-tasking network and the testing device using the same.

### BACKGROUND OF THE DISCLOSURE

Recently, as technologies of artificial intelligence are developing rapidly, there are great achievements in various fields such as medicine, autonomous driving, surveillance, and food recognition.

Generally, a deep learning model is designed to perform one task, and is trained by using a dataset having a task label corresponding to said one task.

In order to perform multiple tasks, each of deep learning models must be separately trained for each of the tasks. Accordingly, there is a limitation that as the number of the tasks to be performed increases, the number of the deep learning models that must be trained increases. This is hard in terms of maintenance of the deep learning models, and also inefficient in terms of storage capacity.

However, for a universal deep learning model, various tasks need to be performed simultaneously.

Recently, in order to overcome such a limitation, various attempts to process the multiple tasks with fast speed are being made, and a method of multi-task learning (MTL) is becoming a good countermeasure to overcome such a limitation.

The method of multi-task learning is related to training one deep learning model capable of performing the multiple tasks, and multiple pieces of useful information made in a training process are shared among each of tasks, thereby contributing to the training process for all the tasks. Further, there are considerable advantages such as efficient calculations, prevention of overfitting, data augmenting effect, etc.

In such a multi-task learning, the training process should be made by using a single dataset labeled for all the tasks, that is, annotated with all ground truths for all the tasks, but it is difficult to prepare the single dataset labeled for all the tasks and thus cannot help but use a plurality of datasets.

However, in case the plurality of datasets are used, each of the datasets is usually labeled only as to any one task among all the tasks, and thus in actual application, there are numerous cases of insufficient labeled data for some tasks at issue.

In addition, it takes considerable time for labeling all dataset with some missing annotations, and thus it is impractical.

Accordingly, an enhanced method for using partly labeled datasets in a multi-tasking network is to be proposed.

### SUMMARY OF THE DISCLOSURE

It is an object of the present disclosure to solve all the aforementioned problems.

It is another object of the present disclosure to train a multi-tasking network by using each of datasets having each of task labels corresponding to each of different tasks.

It is still another object of the present disclosure to train the multi-tasking network through semisupervised learning as to some tasks without their corresponding task labels and through supervised learning as to some other tasks with their corresponding task labels.

It is still yet another object of the present disclosure to train the multi-tasking network by using each of the task labels corresponding to each of the tasks.

In accordance with one aspect of the present disclosure, there is provided a method for training a multi-tasking network configured to perform multi-tasks by using each of datasets having each of task labels corresponding to each of different tasks, the method including steps of: (a) in response to acquiring specific training data from a main dataset including a 1-st sub dataset having a 1-st task label to an n-th sub dataset having an n-th task label, wherein the n is an integer of 2 or more, a learning device inputting the specific training data into each of a 1-st multi-tasking network to an n-th multi-tasking network performing each of n tasks, to thereby instruct each of the 1-st multi-tasking network to the n-th multi-tasking network to perform learning operation on the specific training data and thus to output each of n task results; and (b) the learning device (i) calculating a 1-st task loss to an n-th task loss by referring to a specific task label and each of a 1-st specific task result to an n-th specific task result of the 1-st multi-tasking network to the n-th multi-tasking network for a specific task corresponding to a specific task label included in the specific training data, (ii) calculating a 1-st unlabeled consistency loss group comprised of a (1_1)-st unlabeled consistency loss to a (1_m)-th unlabeled consistency loss to an n-th unlabeled consistency loss group comprised of a (n_1)-st unlabeled consistency loss to an (n_m)-th unlabeled consistency loss by referring to a (j_k)-th task result and an (x_k)-th task result, while increasing j from 1 to n, and while increasing k from 1 to m for each j, wherein m corresponds to remaining tasks other than the specific task among the n tasks, and wherein x corresponds to remaining multi-tasking networks other than any one multi-tasking network specified by j among the 1-st multi-tasking network to the n-th multi-tasking network, and (iii) training the 1-st multi-tasking network to the n-th multi-tasking network by using (iii-1) a total task loss generated by referring to the 1-st task loss to the n-th task loss and (iii-2) a total consistency loss generated by referring to the 1-st unlabeled consistency loss group comprised of the (1_1)-st unlabeled consistency loss to the (1_m)-th unlabeled consistency loss to the n-th unlabeled consistency loss group comprised of the (n_1)-st unlabeled consistency loss to the (n_m)-th unlabeled consistency loss.

As one example, the method may further include: (c) the learning device assessing performances of the 1-st multi-tasking network to the n-th multi-tasking network, thereby selecting an optimal multi-tasking network with a best performance.

As one example, the method may be that at the step of (b), the learning device is configured to generate a labeled consistency loss by referring to a 1-st specific consistency loss to an n-th specific consistency loss, and then generate the total consistency loss by further referring to the labeled consistency loss, wherein the 1-st specific consistency loss is generated by referring to the 1-st specific task result and each of 1-st other specific task results corresponding to the 1-st specific task result, and wherein the n-th specific consistency loss is generated by referring to the n-th specific task result and each of n-th other specific task results corresponding to the n-th specific task result.

As one example, the method may that the learning device is configured to generate a total network loss by adding the total task loss and the total consistency loss, and train the 1-st multi-tasking network to the n-th multi-tasking network by using the total network loss, wherein the total task loss and the total consistency loss are balanced by adjusting an application ratio of the total consistency loss through hyperparameters of the learning device.

As one example, the method may be that the 1-st multi-tasking network to the n-th multi-tasking network are generated by cloning an initial multi-tasking network configured to perform the n tasks.

As one example, the method may be that the learning device is configured to (i) generate a mini batch including at least one 1-st training data sampled from the 1-st sub dataset to at least one n-th training data sampled from the n-th sub dataset, (ii) for each of all training data included in the mini batch, wherein all the training data have been generated at the step of (b) after performing the step (a), (ii-1) generate a mini batch task loss by averaging each of total task losses on each of all the training data and (ii-2) generate a mini batch consistency loss by averaging each of total consistency losses on each of all the training data, and (iii) train the 1-st multi-tasking network to the n-th multi-tasking network by using the mini batch task loss and the mini batch consistency loss.

In addition, in accordance with another aspect of the present disclosure, there is provided a method for testing a trained multi-tasking network by using each of datasets having each of task labels corresponding to each of different tasks, the method including steps of: (a) on condition that a learning device has performed processes of (i) in response to acquiring specific training data from a main dataset including a 1-st sub dataset having a 1-st task label to an n-th sub dataset having an n-th task label, wherein the n is an integer of 2 or more, inputting the specific training data into each of a 1-st multi-tasking network to an n-th multi-tasking network performing each of n tasks to thereby instruct each of the 1-st multi-tasking network to the n-th multi-tasking network to perform learning operation on the specific training data and thus to output each of n task results for training; and (ii) calculating a 1-st task loss to an n-th task loss by referring to each of a 1-st specific task result for training to an n-th specific task result for training of the 1-st multi-tasking network to the n-th multi-tasking network for a specific task corresponding to a specific task label included in the specific training data and the specific task label, calculating a 1-st unlabeled consistency loss group comprised of a (1_1)-st unlabeled consistency loss to a (1_m)-th unlabeled consistency loss to an n-th unlabeled consistency loss group comprised of a (n_1)-st unlabeled consistency loss to an (n_m)-th unlabeled consistency loss by referring to a (j_k)-th task result and an (x_k)-th task result, while increasing j from 1 to n, and while increasing k from 1 to m for each j, wherein m corresponds to remaining tasks other than the specific task among the n tasks, and wherein x corresponds to remaining multi-tasking networks other than any one multi-tasking network specified by j among the 1-st multi-tasking network to the n-th multi-tasking network, and (iii) training the 1-st multi-tasking network to the n-th multi-tasking network by using (iii-1) a total task loss generated by referring to the 1-st task loss to the n-th task loss and (iii-2) a total consistency loss generated by referring to the 1-st unlabeled consistency loss group comprised of the (1_1)-st unlabeled consistency loss to the (1_m)-th unlabeled consistency loss to the n-th unlabeled consistency loss group comprised of the (n_1)-st unlabeled consistency loss to the (n_m)-th unlabeled consistency loss, a testing device acquiring testing data without a task label; and (b) the testing device (i) inputting the testing data to an optimal multi-tasking network having a best performance among the 1-st multi-tasking network to the n-th multi-tasking network, and (ii) instructing the optimal multi-tasking network to perform learning operation on the testing data, to thereby output n task results for testing.

As one example, the method may be that, at the step (a), the learning device has performed processes of (i) generating a mini batch including at least one 1-st training data sampled from the 1-st sub dataset to at least one n-th training data sampled from the n-th sub dataset, (ii) for each of all training data included in the mini batch, wherein all the training data have been generated at the process of (ii) after performing the process of (i), (ii-1) generating a mini batch task loss by averaging each of total task losses on each of all the training data generated in (ii) above, and (ii-2) generating a mini batch consistency loss by averaging each of total consistency losses on each of all the training data, and (iii) training the 1-st multi-tasking network to the n-th multi-tasking network by using the mini batch task loss and the mini batch consistency loss.

In accordance with still another aspect of the present disclosure, there is provided a learning device for training a multi-tasking network configured to perform multi-tasks by using each of datasets having each of task labels corresponding to each of different tasks, the learning device including: a memory storing instructions for training the multi-tasking network configured to perform the multi-tasks by using each of the datasets having each of the task labels corresponding to each of the different tasks; and a processor performing operations for training the multi-tasking network configured to perform the multi-tasks by using each of the datasets having each of the task labels corresponding to each of the different tasks according to the instructions stored in the memory; wherein the processor performs (I) a process of, in response to acquiring specific training data from a main dataset including a 1-st sub dataset having a 1-st task label to an n-th sub dataset having an n-th task label, wherein the n is an integer of 2 or more, inputting the specific training data into each of a 1-st multi-tasking network to an n-th multi-tasking network performing each of n tasks, to thereby instruct each of the 1-st multi-tasking network to the n-th multi-tasking network to perform learning operation on the specific training data and thus to output each of n task results; and (II) processes of (II-1) calculating a 1-st task loss to an n-th task loss by referring to a specific task label and each of a 1-st specific task result to an n-th specific task result of the 1-st multi-tasking network to the n-th multi-tasking network for a specific task corresponding to the specific task label included in the specific training data, (II-2) calculating a 1-st unlabeled consistency loss group comprised of a (1_1)-st unlabeled consistency loss to a (1_m)-th unlabeled consistency loss to an n-th unlabeled consistency loss group comprised of a (n_1)-st unlabeled consistency loss to an (n_m)-th unlabeled consistency loss by referring to a (j_k)-th task result and an (x_k)-th task result, while increasing j from 1 to n, and while increasing k from 1 to m for each j, wherein m corresponds to remaining tasks other than the specific task among the n tasks, and wherein x corresponds to remaining multi-tasking networks other than any one multi-tasking network specified by j among the 1-st multi-tasking network to the n-th multi-tasking network, and (II-3) training the 1-st multi-tasking network to the n-th multi-tasking network by using (II-3-a) a total task loss generated by referring to the 1-st task loss to the n-th task loss and (II-3-b) a total consistency loss generated by referring to the 1-st unlabeled consistency loss group comprised of the (1_1)-st unlabeled consistency loss to the (1 m)-th unlabeled consistency loss to the n-th unlabeled consistency loss group comprised of the (n_1)-st unlabeled consistency loss to the (n_m)-th unlabeled consistency loss.

As one example, the processor may further perform (III) the learning device assessing performances of the 1-st multi-tasking network to the n-th multi-tasking network, thereby selecting an optimal multi-tasking network with a best performance.

As one example, the processor, at the process of (II), may be configured to generate a labeled consistency loss by referring to a 1-st specific consistency loss to an n-th specific consistency loss, and generate the total consistency loss by further referring to the labeled consistency loss, wherein the 1-st specific consistency loss is generated by referring to the 1-st specific task result and each of 1-st other specific task results corresponding to the 1-st specific task result, and wherein the n-th specific consistency loss is generated by referring to the n-th specific task result and each of n-th other specific task results corresponding to the n-th specific task result.

As one example, the processor may be configured to generate a total network loss by adding the total task loss and the total consistency loss, and train the 1-st multi-tasking network to the n-th multi-tasking network by using the total network loss, wherein the total task loss and the total consistency loss are balanced by adjusting an application ratio of the total consistency loss through hyperparameters of the learning device.

As one example, the 1-st multi-tasking network to the n-th multi-tasking network may be those generated by cloning an initial multi-tasking network configured to perform the n tasks.

As one example, the processor may be configured to (i) generate a mini batch including at least one 1-st training data sampled from the 1-st sub dataset to at least one n-th training data sampled from the n-th sub dataset, (ii) for each of all training data included in the mini batch, wherein all the training data have been generated at the step of (b) after performing the step (a), (ii-1) generate a mini batch task loss by averaging each of total task losses on each of all the training data and (ii-2) generate a mini batch consistency loss by averaging each of total consistency losses on each of all the training data, and (iii) train the 1-st multi-tasking network to the n-th multi-tasking network by using the mini batch task loss and the mini batch consistency loss.

In addition, in accordance with still yet another aspect of the present disclosure, there is provided a testing device for testing a trained multi-tasking network by using each of datasets having each of task labels corresponding to each of different tasks, the testing device including: a memory storing instructions for testing the trained multi-tasking network by using each of the datasets having each of the task labels corresponding to each of the different tasks; and a processor performing operations for testing the trained multi-tasking network by using each of the datasets having each of the task labels corresponding to each of the different tasks according to the instructions stored in the memory; wherein the processor performs (I) on condition that a learning device, has performed processes of (i) in response to acquiring specific training data from a main dataset including a 1-st sub dataset having a 1-st task label to an n-th sub dataset having an n-th task label, wherein the n is an integer of 2 or more, inputting the specific training data into each of a 1-st multi-tasking network to an n-th multi-tasking network performing each of n tasks to thereby instruct each of the 1-st multi-tasking network to the n-th multi-tasking network to perform learning operation on the specific training data and thus to output each of n task results for training; and (ii) calculating a 1-st task loss to an n-th task loss by referring to each of a 1-st specific task result for training to an n-th specific task result for training of the 1-st multi-tasking network to the n-th multi-tasking network for a specific task corresponding to a specific task label included in the specific training data and the specific task label, calculating a 1-st unlabeled consistency loss group comprised of a (1_1)-st unlabeled consistency loss to a (1_m)-th unlabeled consistency loss to an n-th unlabeled consistency loss group comprised of a (n_1)-st unlabeled consistency loss to an (n_m)-th unlabeled consistency loss by referring to a (j_k)-th task result and an (x_k)-th task result, while increasing j from 1 to n, and while increasing k from 1 to m for each j, wherein m corresponds to remaining tasks other than the specific task among the n tasks, and wherein x corresponds to remaining multi-tasking networks other than any one multi-tasking network specified by j among the 1-st multi-tasking network to the n-th multi-tasking network, and (iii) training the 1-st multi-tasking network to the n-th multi-tasking network by using (iii-1) a total task loss generated by referring to the 1-st task loss to the n-th task loss and (iii-2) a total consistency loss generated by referring to the 1-st unlabeled consistency loss group comprised of the (1_1)-st unlabeled consistency loss to the (1 m)-th unlabeled consistency loss to the n-th unlabeled consistency loss group comprised of the (n_1)-st unlabeled consistency loss to the (n_m)-th unlabeled consistency loss, a testing device acquiring testing data without a task label; and (II) the testing device (i) inputting the testing data to an optimal multi-tasking network having a best performance among the 1-st multi-tasking network to the n-th multi-tasking network, and (ii) instructing the optimal multi-tasking network to perform learning operation on the testing data, to thereby output n task results for testing.

As one example, the testing device may be that, at the process (I), the learning device has performed processes of (i) generating a mini batch including at least one 1-st training data sampled from the 1-st sub dataset to at least one n-th training data sampled from the n-th sub dataset, (ii) for each of all training data included in the mini batch, wherein all the training data have been generated at the process of (II) after performing (i), (ii-1) generating a mini batch task loss by averaging each of total task losses on each of all the training data generated in (ii) above, and (ii-2) generating a mini batch consistency loss by averaging each of total consistency losses on each of all the training data, and (iii) training the 1-st multi-tasking network to the n-th multi-tasking network by using the mini batch task loss and the mini batch consistency loss.

In addition, recordable media that are readable by a computer for storing a computer program to execute the method of the present disclosure is further provided.

### BRIEF DESCRIPTION OF THE DRAWINGS

The above and other objects and features of the present disclosure will become apparent from the following description of preferred embodiments given in conjunction with the accompanying drawings.

FIG. 1 is a drawing schematically illustrating a learning device for training a multi-tasking network by using each of datasets having each of task labels corresponding to each of different tasks in accordance with one example embodiment of the present disclosure.

FIG. 2 is a drawing schematically illustrating a configuration of training the multi-tasking network by using each of the datasets having each of task labels corresponding to each of different tasks in accordance with one example embodiment of the present disclosure.

FIG. 3 is a drawing schematically illustrating a configuration of training the multi-tasking network capable of performing two tasks in accordance with one example embodiment of the present disclosure.

FIG. 4 is a drawing schematically illustrating a configuration of assessing a performance of a trained multi-tasking network by using a verification dataset having each of the task labels corresponding to each of the different tasks in accordance with one example embodiment of the present disclosure.

FIG. 5 is a drawing schematically illustrating a testing device for testing the trained multi-tasking network by using each of the datasets having each of the task labels corresponding to each of the different tasks in accordance with one example embodiment of the present disclosure.

FIG. 6 is a drawing schematically illustrating a configuration of testing the trained multi-tasking network by using each of the datasets having each of the task labels corresponding to each of the different tasks in accordance with one example embodiment of the present disclosure.

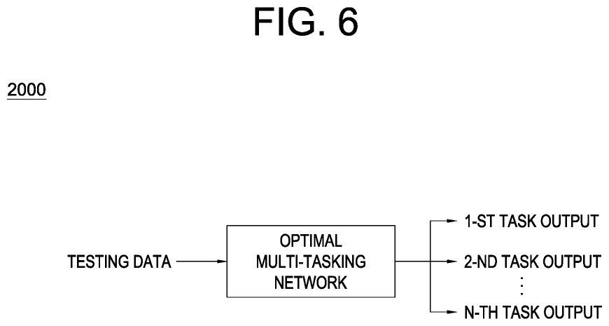

### DETAILED DESCRIPTION OF THE PREFERRED EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

To allow those skilled in the art to carry out the present disclosure easily, the example embodiments of the present disclosure will be explained by referring to attached diagrams in detail as shown below.

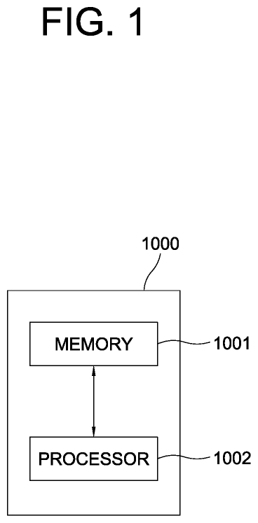

FIG. 1 is a drawing schematically illustrating a learning device for training a multi-tasking network by using each of datasets having each of task labels corresponding to each of different tasks in accordance with one example embodiment of the present disclosure.

By referring to FIG. 1, the learning device 1000 in accordance with one example embodiment of the present disclosure may include a memory 1001 for storing instructions to train a multi-tasking network by using each of the datasets having each of the task labels corresponding to each of the different tasks, and a processor 1002 performing operations for training the multi-tasking network by using each of the datasets having each of the task labels corresponding to each of the different tasks according to the instructions in the memory 1001.

Specifically, the learning device 1000 may achieve a desired system performance by using combinations of at least one computing device and at least one computer software, e.g., a computer processor, a memory, a storage, an input device, an output device, or any other conventional computing components, an electronic communication device such as a router or a switch, an electronic information storage system such as a network-attached storage (NAS) device and a storage area network (SAN) as the computing device and any instructions that allow the computing device to function in a specific way as the computer software.

In addition, the processor of the computing device may include hardware configuration of MPU (Micro Processing Unit) or CPU (Central Processing Unit), cache memory, data bus, etc. Additionally, the computing device may further include OS and software configuration of applications that achieve specific purposes.

However, the computing device may include an integrated processor in which a medium, a processor and a memory are integrated as the case may be.

Meanwhile, the processor 1002 of the learning device 1000 may perform a process of (I) in response to acquiring specific training data from a main dataset including a 1-st sub dataset having a 1-st task label to an n-th sub dataset having an n-th task label, wherein the n is an integer of 2 or more, inputting the specific training data into each of a 1-st multi-tasking network to an n-th multi-tasking network performing each of n tasks, to thereby instruct each of the 1-st multi-tasking network to the n-th multi-tasking network to perform learning operation on the specific training data and thus to output each of n task results. In addition, the processor 1002 may perform (II) processes of, (II-1) calculating a 1-st task loss to an n-th task loss by referring to a specific task label and each of a 1-st specific task result to an n-th specific task result of the 1-st multi-tasking network to the n-th multi-tasking network for a specific task corresponding to the specific task label included in the specific training data, (II-2) calculating a 1-st unlabeled consistency loss group comprised of a (1_1)-st unlabeled consistency loss to a (1_m)-th unlabeled consistency loss to an n-th unlabeled consistency loss group comprised of a (n_1)-st unlabeled consistency loss to an (n_m)-th unlabeled consistency loss by referring to a (j_k)-th task result and an (x_k)-th task result, while increasing j from 1 to n, and while increasing k from 1 to m for each j, wherein m corresponds to remaining tasks other than the specific task among the n tasks, and wherein x corresponds to remaining multi-tasking networks other than any one multi-tasking network specified by j among the 1-st multi-tasking network to the n-th multi-tasking network, and (II-3) training the 1-st multi-tasking network to the n-th multi-tasking network by using (II-3-a) a total task loss generated by referring to the 1-st task loss to the n-th task loss and (II-3-b) a total consistency loss generated by referring to the 1-st unlabeled consistency loss group comprised of the (1_1)-st unlabeled consistency loss to the (1_m)-th unlabeled consistency loss to the n-th unlabeled consistency loss group comprised of the (n_1)-st unlabeled consistency loss to the (n_m)-th unlabeled consistency loss.

Meanwhile, the processor 1002 may be configured to (i) generate a mini batch including at least one 1-st training data sampled from the 1-st sub dataset to at least one n-th training data sampled from the n-th sub dataset, (ii) for each of all training data included in the mini batch, wherein all the training data have been generated at the processes of (II) after performing the process of (I), (ii-1) generate a mini batch task loss by averaging each of total task loss on each of all the training data and (ii-2) generate a mini batch consistency loss by averaging each of total consistency losses on each of all the training data, and (iii) train the 1-st multi-tasking network to the n-th multi-tasking network by using the mini batch task loss and the mini batch consistency loss.

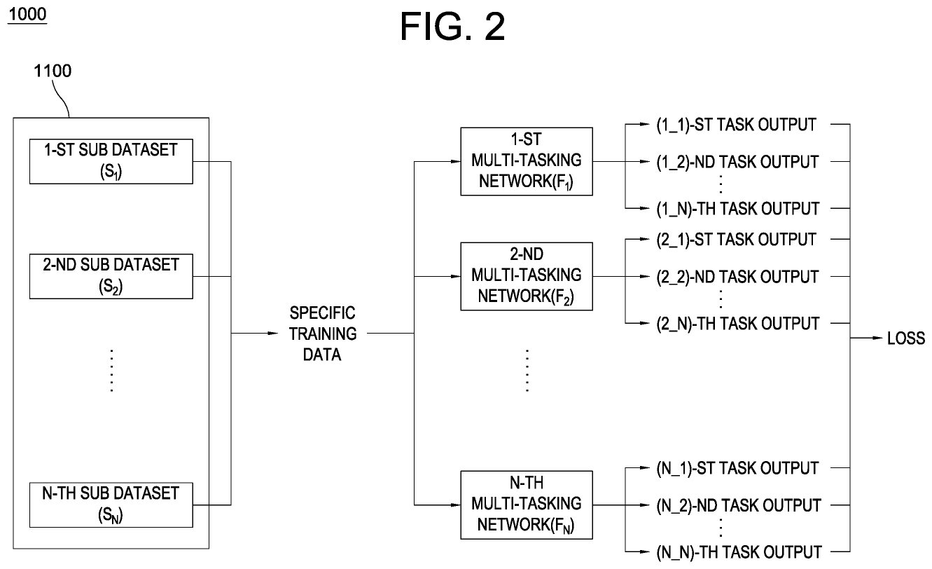

A method for training the multi-tasking network by using each of the datasets having each of the task labels corresponding to each of the different tasks using the learning device 1000 in accordance with one example embodiment of the present disclosure configured as above is explained by referring to FIG. 2 as follows.

Firstly, a main dataset 1100 necessary for training the multi-tasking network so as to perform n tasks can be generated. Herein, the multi-tasking network includes a single deep learning model. The n may be an integer of 2 or more.

The main dataset 1100 may include a 1-st sub dataset S₁ to an n-th dataset Sₙ. Herein, the 1-st sub dataset S₁ has a 1-st task label which is a ground truth corresponding to a 1-st task, and the n-th sub dataset Sₙ has an n-th task label which is a ground truth corresponding to an n-th task. Herein, the 1-st task label may include many task labels related to the 1-st task and the n-th task label may include many task labels related to the n-th task. The main dataset 1100 may be acquired by using the 1-st sub dataset S₁ to the n-th sub dataset Sₙ as they are. Herein, the 1-st sub dataset S₁ is comprised of training data having the 1-st task label for learning of the 1-st task and the n-th sub dataset Sₙ is comprised of training data having the n-th task label for learning of the n-th task. As another example, the main dataset 1100 may be acquired by generating the 1-st sub dataset S₁ to the n-th sub dataset Sₙ. Herein, the 1-st sub dataset S₁ to the n-th sub dataset Sₙ are generated by adding each of task labels to collected raw data for learning of each of the tasks.

In addition, an initial multi-tasking network configured to perform n multi-tasks may be generated, and then a 1-st multi-tasking network F₁ to an n-th multi-tasking network Fₙ are generated by cloning the initial multi-tasking network. Herein, the n multi-tasks may be tasks that are different from each other but are associated with each other such as person re-identification (reID) for identifying identical persons in an image or in a video, or pedestrian attribute recognition (PAR) for identifying a characteristic of a person in an image or in a video.

On condition that the main dataset 1100, the 1-st multi-tasking network F₁ to the n-th multi-tasking network Fₙ have been generated, the learning device 1000 may acquire a specific training data from the main dataset 1100 comprised of the 1-st sub dataset S₁ to the n-th sub dataset Sₙ. Herein, the 1-st sub dataset S₁ has the 1-st task label and the n-th sub dataset Sₙ has the n-th task label.

In addition, in response to acquiring the specific training data from the main dataset 1100, the learning device 1000 may input the specific training data into each of the 1-st multi-tasking network F₁ to the n-th multi-tasking network Fₙ capable of performing each of the n tasks, to thereby instruct each of the 1-st multi-tasking network F₁ to the n-th multi-tasking network Fₙ to perform learning operation on the specific training data and thus to output each of n task results. That is, if j is a constant increasing from 1 to n, a j-th multi task network Fⱼ performs learning operation on the specific training data and thus outputs a (j_1)-st task result to a (j_n)-th task result.

Thereafter, the learning device 1000 may calculate a 1-st task loss to an n-th task loss by referring to the specific task label and each of the 1-st specific task result to the n-th specific task result of the 1-st multi-tasking network F₁ to the n-th multi-tasking network Fₙ for the specific task corresponding to the specific task label included in the specific training data.

In addition, the learning device 1000 may calculate a 1-st unlabeled consistency loss group comprised of a (1_1)-st unlabeled consistency loss to a (1_m)-th unlabeled consistency loss to an n-th unlabeled consistency loss group comprised of a (n_1)-st unlabeled consistency loss to an (n_m)-th unlabeled consistency loss by referring to a (j_k)-th task result and an (x_k)-th task result, while increasing j from 1 to n, and while increasing k from 1 to m for each j. Herein, m may correspond to remaining tasks other than the specific task among the n tasks, and x may correspond to remaining multi-tasking networks other than any one multi-tasking network specified by j among the 1-st multi-tasking network to the n-th multi-tasking network.

In addition, the learning device 1000 may train the 1-st multi-tasking network F₁ to the n-th multi-tasking network Fₙ by using (1) a total task loss generated by referring to the 1-st task loss to the n-th task loss and (2) a total consistency loss generated by referring to the 1-st unlabeled consistency loss group to the n-th unlabeled consistency loss group. Herein, the 1-st unlabeled consistency loss group is comprised of the (1_1)-st unlabeled consistency loss to the (1_m)-th unlabeled consistency loss and the n-th unlabeled consistency loss group is comprised of the (n_1)-st unlabeled consistency loss to the (n_m)-th unlabeled consistency loss.

That is, the learning device 1000 may generate the total task loss by using the task labels, i.e., the 1-st task label to the n-th task label, which are the ground truths and the corresponding task results as to the tasks corresponding to the task labels of the training data, and generate unlabeled consistency loss by using output values of multi-tasking networks that are different from each other as pseudo labels for other tasks without task labels, and train all the multi-tasking networks by using the total task loss and the total consistency loss. Herein, the learning device 1000 may, for the specific unlabeled task without a task label, generate each of the unlabeled consistency loss by using output values of other multi-tasking networks as pseudo labels, and generate a specific unlabeled consistency loss for a specific unlabeled task by using an average value of its corresponding unlabeled consistency loss.

In addition, the learning device 1000 may generate a labeled consistency loss by referring to 1-st specific consistency loss to n-th specific consistency loss, and then generate the total consistency loss by further referring to the labeled consistency loss. Herein the 1-st specific consistency loss is generated by referring to the 1-st specific task result and each of 1-st other specific task results corresponding to the 1-st specific task result, and the n-th specific consistency loss is generated by referring to the n-th specific task result and each of n-th other specific task results corresponding to the n-th specific task result.

In addition, the learning device 1000 may generate a total network loss by adding the total task loss and the total consistency loss, and then train the 1-st multi-tasking network F₁ to the n-th multi-tasking network Fₙ by using the total network loss. Herein, the total task loss and the total consistency loss are balanced by adjusting an application ratio of the total consistency loss through hyperparameters of the learning device 1000.

Meanwhile, it was explained above that the learning device 1000 trains the 1-st multi-tasking network F₁ to the n-th multi-tasking network Fₙ by using the specific training data, but unlike this, the learning device 1000 may generate mini batches by using multiple training data, and train the 1-st multi-tasking network F₁ to the n-th multi-tasking network Fₙ by using each of the mini batches.

That is, the learning device 1000 may (i) generate a mini batch including at least one 1-st training data sampled from the 1-st sub dataset S₁ to at least one n-th training data sampled from the n-th sub dataset Sₙ, (ii) for each of all the training data included in the mini batch, wherein all the training data have been generated in a similar way to the case of the specific training data as described above, (ii-1) generate a mini batch task loss by averaging each of the total task losses on each of all the training data and (ii-2) generate a mini batch consistency loss by averaging each of the total consistency losses on each of all the training data, and (iii) train the 1-st multi-tasking network F₁ to the n-th multi-tasking network Fₙ by using the mini batch task loss and the mini batch consistency loss.

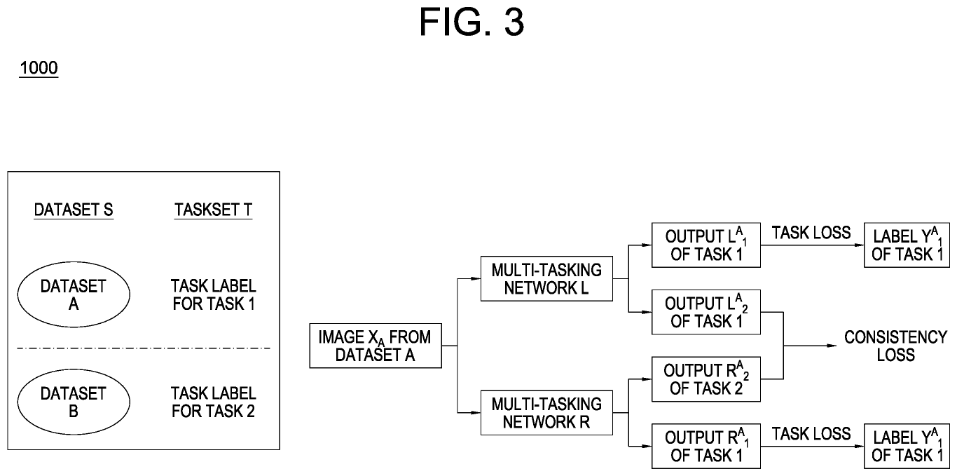

In order to help understanding of the method for training the multi-tasking network in accordance with one example embodiment of the present disclosure, the process of training the multi-tasking network configured to perform two tasks that are different from each other is explained by referring to FIG. 3 as follows.

According to FIG. 3, a drawing is schematically illustrating a process of training a multi-tasking network L and a multi-tasking network R to perform Task 1 for person re-identification (reID) capable of identifying identical persons in an image and Task 2 for pedestrian attribute recognition (PAR) capable of identifying characteristic of a person in an image simultaneously.

Dataset S may include Dataset A having a task label Y^{A}₁ for Task 1 and Dataset B having a task label Y^{B}₂ for Task 2.

In addition, a mini batch may include at least one training image S^{b}_{A} sampled from Dataset A and at least one training image S^{b}_{B} sampled from Dataset B.

In addition, for a training image X^{A} sampled from Dataset A, the multi-tasking network L outputs Output L^{A}₁ for Task 1 and Output L^{A}₂ for Task 2, and the multi-tasking network R outputs Output R^{A}₁ for Task 1 and Output R^{A}₂ for Task 2.

In addition, for a training image X^{B} sampled from Dataset B, the multi-tasking network L outputs Output L^{B}₁ for Task 1 and Output L^{B}₂ for Task 2, and the multi-tasking network R outputs Output R^{B}₁ for Task 1 and Output R^{B}₂ for Task 2.

According to the output information as described above, the total task loss [symbol] ^{GT} may be calculated as follows.

$${ℒ}^{G T} = \frac{1}{\vert {{S}^{b}}_{A} \vert} {\sum }_{s ∈ {{S}^{b}}_{A}} ( {{ℒ}^{G T}}_{1} ( {{L}^{A}}_{1} , {{Y}^{A}}_{1} ) + {{ℒ}^{G T}}_{1} ( {{R}^{A}}_{1} , {{Y}^{A}}_{1} ) ) + \frac{1}{\vert {{S}^{b}}_{B} \vert} {\sum }_{s ∈ {{S}^{b}}_{B}} ( {{ℒ}^{G T}}_{2} ( {{L}^{B}}_{2} , {{Y}^{B}}_{2} ) + {{ℒ}^{G T}}_{2} ( {{R}^{B}}_{2} , {{Y}^{B}}_{2} ) )$$

In addition, the consistency loss [symbol] ᵤ^{con} for unlabeled data may be calculated as follows.

$${ℒ}_{u}^{c o n} = \frac{1}{\vert {{S}^{b}}_{A} \vert} {\sum }_{s ∈ {{S}^{b}}_{A}} ( {{ℒ}^{con}}_{2} ( {{L}^{A}}_{2} , {{R}^{A}}_{2} ) + {{ℒ}^{con}}_{2} ( {{R}^{A}}_{2} , {{L}^{A}}_{2} ) ) + \frac{1}{\vert {{S}^{b}}_{B} \vert} {\sum }_{s ∈ {{S}^{b}}_{B}} ( {{ℒ}^{con}}_{1} ( {{L}^{B}}_{1} , {{R}^{B}}_{1} ) + {{ℒ}^{con}}_{1} ( {{R}^{B}}_{1} , {{L}^{B}}_{1} ) )$$

In addition, the consistency loss [symbol] ₗ^{con} for labeled data may be calculated as follows.

$${ℒ}_{l}^{c o n} = \frac{1}{\vert {{S}^{b}}_{A} \vert} {\sum }_{s ∈ {{S}^{b}}_{A}} ( {{ℒ}^{con}}_{1} ( {{L}^{A}}_{1} , {{R}^{A}}_{1} ) + {{ℒ}^{con}}_{1} ( {{R}^{A}}_{1} , {{L}^{A}}_{1} ) ) + \frac{1}{\vert {{S}^{b}}_{B} \vert} {\sum }_{s ∈ {{S}^{b}}_{B}} ( {{ℒ}^{con}}_{2} ( {{L}^{B}}_{2} , {{R}^{B}}_{2} ) + {{ℒ}^{con}}_{2} ( {{R}^{B}}_{2} , {{L}^{B}}_{2} ) )$$

In addition, the total consistency loss [symbol] ^{con} may be calculated as follows.

$${ℒ}^{c o n} = {ℒ}_{u}^{c o n} + {ℒ}_{l}^{c o n}$$

Accordingly, the total network loss [symbol] for training can be calculated as follows.

$$ℒ = {ℒ}^{G T} + {λℒ}^{c o n}$$

The λ may be a hyperparameter for balancing the total task loss and the total consistency loss.

Meanwhile, in the above, explanation was made as to the learning using the mini batch, but in case of using a training data, the mathematical formulae may use only output values for any one training image, and thus it can be easily understood by a skilled person in the art.

Referring to FIG. 2 again, according to the explanation above, on condition that the 1-st multi-tasking network F₁ to the n-th multi-tasking network Fₙ have been trained, the learning device 1000 may assess the performances of the 1-st multi-tasking network to the n-th multi-tasking network, thereby selecting an optimal multi-tasking network with a best performance.

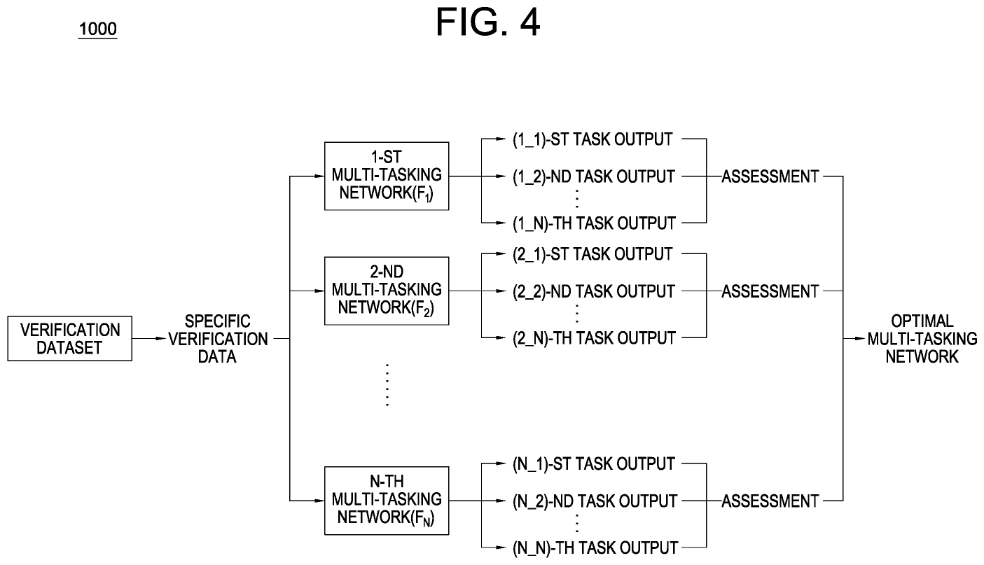

By referring to FIG. 4, this can be explained in further detail as follows.

Firstly, the learning device 1000 may generate a verification dataset by sampling verification data from the main dataset comprised of the 1-st sub dataset to the n-th sub dataset. Herein, the 1-st sub dataset has the 1-st task label and the n-th sub dataset has the n-th task label.

In addition, the learning device 1000 may input a specific verification data included in the verification dataset into each of the trained 1-st multi-tasking network F₁ to the trained n-th multi-tasking network Fₙ, to thereby instruct each of the trained 1-st multi-tasking network F₁ to the trained n-th multi-tasking network Fₙ to perform learning operation on the specific verification data and thus to output each of n task results. In a similar way, the learning device 1000 may perform the same operation on all the verification data included in the verification dataset.

Thereafter, the learning device 1000 may assess performances of each of the trained 1-st multi-tasking network F₁ to the trained n-th multi-tasking network Fₙ by referring to n task results on all the verification data in each of the trained 1-st multi-tasking network F₁ to the trained n-th multi-tasking network Fₙ.

Herein, the assessment of the performances of each of the trained 1-st multi-tasking network F₁ to the trained n-th multi-tasking network Fₙ may be performed by using various assessment indices.

As one example, in case the 1-st multi-tasking network F₁ to the n-th multi-tasking network Fₙ are prediction models, assessment indices such as MSE (Mean Squared Error), RMSE (Root Mean Squared Error), MAE (Mean Absolute Error), and MAPE (Mean Absolute Percentage Error), etc. may be used. Such values represent errors in the end, and thus, it means that the smaller the value, the better the performance of the model. Herein, MSE squares differences of an actual value and a predicted value and then averages the squared differences. Further, RMSE (Root Mean Squared Error) applies root to MSE since MSE finds the square of the error and thus MSE has a characteristic of a value being greater than the average of the actual error. Furthermore, MAE (Mean Absolute Error) converts a difference of the actual value and the predicted value to an absolute value and then averages the absolute value. Furthermore, MAPE (Mean Absolute Percentage Error) remedies the disadvantages of MSE and RMSE.

As another example, in case the 1-st multi-tasking network F₁ to the n-th multi-tasking network Fₙ are Classification Models, assessment indices such as Accuracy indicating the number of data accurately predicted among the total data, Confusion Matrix which organizes a predicted category of classification and a classified category of the actual data in a form of Cross Table, Precision indicating a ratio of true positive among those determined as the positive, Recall indicating a ratio correctly determining as the positive among those truly positive, and F1-score made by combining Precision and Recall. Herein, all of the Accuracy, the Precision, the Recall and the F1-score have values between 0 and 1, and thus it means that the closer the value is to 1, the better the performance of the model.

In addition, the learning device 1000 may select any one multi-tasking network with the best performance among the trained 1-st multi-tasking network to the trained n-th multi-tasking network, as the optimal multi-tasking network, by referring to the assessment result.

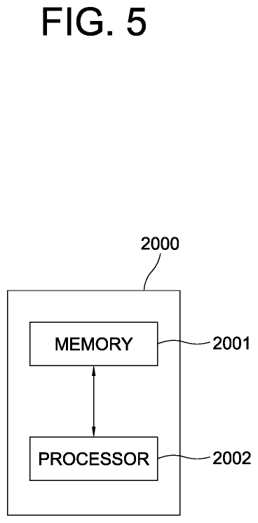

FIG. 5 is a drawing schematically illustrating a testing device for testing a trained multi-tasking network by using each of the datasets having each of the task labels corresponding to each of the different tasks in accordance with one example embodiment of the present disclosure.

By referring to FIG. 5, a testing device 2000 in accordance with one example embodiment of the present disclosure may include a memory 2001 for storing instructions to test a trained multi-tasking network by using each of datasets having each of task labels corresponding to each of different tasks, and a processor 2002 performing operations for testing the trained multi-tasking network by using each of datasets having each of task labels corresponding to each of different tasks according to the instructions in the memory 2001.

Specifically, the test device 2000 may achieve a desired system performance by using combinations of at least one computing device and at least one computer software, e.g., a computer processor, a memory, a storage, an input device, an output device, or any other conventional computing components, an electronic communication device such as a router or a switch, an electronic information storage system such as a network-attached storage (NAS) device and a storage area network (SAN) as the computing device and any instructions that allow the computing device to function in a specific way as the computer software.

In addition, the processor of the computing device may include hardware configuration of MPU (Micro Processing Unit) or CPU (Central Processing Unit), cache memory, data bus, etc. Additionally, the computing device may further include OS and software configuration of applications that achieve specific purposes.

However, the computing device may include an integrated processor in which a medium, a processor and a memory are integrated as the case may be.

Meanwhile, on condition that the learning device has trained the 1-st multi-tasking network to the n-th multi-tasking network, and then has assessed the performances of the trained 1-st multi-tasking network to the trained n-th multi-tasking network, thereby selecting the optimal multi-tasking network with the best performance as explained above by referring to FIG. 2 to FIG. 4, the processor 2002 of the testing device 2000 may acquire testing data. Herein, the testing data are without task labels, and as one example, the testing data can be images taken through an image sensor such as a camera. In addition, the processor 2002 may input the testing data into the optimal multi-tasking network, to thereby instruct the optimal multi-tasking network to perform the learning operation on the testing data, and thus to output n task results for testing on the testing data.

A method for testing the optimal multi-tasking network by using the testing device in accordance with one example embodiment of the present disclosure configured as above is explained as follows.

In advance, the learning device has performed processes of (i) in response to acquiring specific training data from a main dataset including a 1-st sub dataset having a 1-st task label to an n-th sub dataset having an n-th task label, wherein the n is an integer of 2 or more, inputting the specific training data into each of a 1-st multi-tasking network to an n-th multi-tasking network performing each of n tasks to thereby instruct each of the 1-st multi-tasking network to the n-th multi-tasking network to perform learning operation on the specific training data and thus to output each of n task results for training; and (ii) calculating a 1-st task loss to an n-th task loss by referring to each of a 1-st specific task result for training to an n-th specific task result for training of the 1-st multi-tasking network to the n-th multi-tasking network for a specific task corresponding to a specific task label included in the specific training data and the specific task label, calculating a 1-st unlabeled consistency loss group comprised of a (1_1)-st unlabeled consistency loss to a (1_m)-th unlabeled consistency loss to an n-th unlabeled consistency loss group comprised of a (n_1)-st unlabeled consistency loss to an (n_m)-th unlabeled consistency loss by referring to a (j_k)-th task result and an (x_k)-th task result, while increasing j from 1 to n, and while increasing k from 1 to m for each j, wherein m corresponds to remaining tasks other than the specific task among the n tasks, and wherein x corresponds to remaining multi-tasking networks other than any one multi-tasking network specified by j among the 1-st multi-tasking network to the n-th multi-tasking network, and (iii) training the 1-st multi-tasking network to the n-th multi-tasking network by using (iii-1) a total task loss generated by referring to the 1-st task loss to the n-th task loss and (iii-2) a total consistency loss generated by referring to the 1-st unlabeled consistency loss group comprised of the (1_1)-st unlabeled consistency loss to the (1 m)-th unlabeled consistency loss to the n-th unlabeled consistency loss group comprised of the (n_1)-st unlabeled consistency loss to the (n_m)-th unlabeled consistency loss.

That is, on condition that the optimal multi-tasking network has been selected as described in the explanation related to FIG. 2 to FIG. 4, the testing device 2000 may acquire testing data without a task label.

In addition, the testing device 2000 may (i) input the testing data to the optimal multi-tasking network having the best performance among the 1-st multi-tasking network to the n-th multi-tasking network, and then (ii) instruct the optimal multi-tasking network to perform the learning operation on the testing data, to thereby output the n task results for testing.

In this specification, the number of the datasets, i.e., the 1-st dataset to the n-th dataset, the number of the task labels, i.e., the 1-st task label to the n-th task label, the number of tasks, i.e., the 1-st task to the n-th task, and the number of multi-tasking networks, i.e., the 1-st multi-tasking network to the n-th multi-tasking networks, are considered as “n” for the convenience of explanation, but the scope of the present invention is not limited thereto. That is, if the number of tasks is “n”, then the number of the task labels is also “n”, but the number of the datasets can be more than “n” and the number of the multi-tasking networks can also be more than “n” as the case may be. However, even if the number of the datasets is more than “n” and/or the number of the multi-tasking networks is more than “n”, the present invention explained above can also be applied in the similar way because of the following two reasons. The first reason is that “n” datasets and “n” multi-tasking networks can be respectively selected among all the datasets and all the multi-tasking networks (even if the number of the datasets is more than “n” and the number of the multi-tasking networks is more than “n”) and the second reason is that the number of the datasets and the number of the multi-tasking networks can be increased as a scaled-up system only on the basis of the “n” datasets and the “n” multi-tasking networks. Meanwhile, even in case one dataset can have labels for more than one task, the present invention can still be applied thereto in the similar way, since said one dataset can be acquired by combining a first dataset having a first label and a second dataset having a second label, that is, since two or more datasets can be combined into one dataset on the basis of the “n” datasets.

There is a technical effect of training a multi-tasking network by using each of datasets having each of task labels corresponding to each of different tasks.

There is another technical effect of training the multi-tasking network through semisupervised learning as to some tasks without their corresponding task labels and through supervised learning as to some other tasks with their corresponding task labels.

There is still another technical effect of training the multi-tasking network by using each of the task labels corresponding to each of the tasks.

Besides, the embodiments of the present disclosure as explained above can be implemented in a form of executable program command through a variety of computer means recordable to computer readable media. The computer readable media may store solely or in combination, program commands, data files, and data structures. The program commands recorded in the media may be components specially designed for the present disclosure or may be usable for a skilled human in a field of computer software. The computer readable media include, but are not limited to, magnetic media such as hard drives, floppy diskettes, magnetic tapes, memory cards, solid-state drives, USB flash drives, optical media such as CD-ROM and DVD, magneto-optical media such as floptical diskettes and hardware devices such as a read-only memory (ROM), a random access memory (RAM), and a flash memory specially designed to store and carry out program commands. Program commands may include not only a machine language code made by a compiler but also a high level code that can be used by an interpreter etc., which is executed by a computer. The aforementioned hardware device may work as more than a software module to perform the action of the present disclosure and they may do the same in the opposite case.

As seen above, the present disclosure has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method for training a multi-tasking network configured to perform multi-tasks by using each of datasets having each of task labels corresponding to each of different tasks, the method comprising:
(a) in response to acquiring specific training data from a main dataset including a 1-st sub dataset having a 1-st task label to an n-th sub dataset having an n-th task label, wherein the n is an integer of 2 or more, a learning device inputting the specific training data into each of a 1-st multi-tasking network to an n-th multi-tasking network performing each of n tasks, to thereby instruct each of the 1-st multi-tasking network to the n-th multi-tasking network to perform learning operation on the specific training data and thus to output each of n task results; and
(b) the learning device (i) calculating a 1-st task loss to an n-th task loss by referring to a specific task label and each of a 1-st specific task result to an n-th specific task result of the 1-st multi-tasking network to the n-th multi-tasking network for a specific task corresponding to the specific task label included in the specific training data, (ii) calculating a 1-st unlabeled consistency loss group comprised of a (1_1)-st unlabeled consistency loss to a (1_m)-th unlabeled consistency loss to an n-th unlabeled consistency loss group comprised of a (n_1)-st unlabeled consistency loss to an (n_m)-th unlabeled consistency loss by referring to a (j_k)-th task result and an (x_k)-th task result, while increasing j from 1 to n, and while increasing k from 1 to m for each j, wherein m corresponds to remaining tasks other than the specific task among the n tasks, and wherein x corresponds to remaining multi-tasking networks other than any one multi-tasking network specified by j among the 1-st multi-tasking network to the n-th multi-tasking network, and (iii) training the 1-st multi-tasking network to the n-th multi-tasking network by using (iii-1) a total task loss generated by referring to the 1-st task loss to the n-th task loss and (iii-2) a total consistency loss generated by referring to the 1-st unlabeled consistency loss group comprised of the (1_1)-st unlabeled consistency loss to the (1_m)-th unlabeled consistency loss to the n-th unlabeled consistency loss group comprised of the (n_1)-st unlabeled consistency loss to the (n_m)-th unlabeled consistency loss.

2. The method of claim 1, further comprising:
(c) the learning device assessing performances of the 1-st multi-tasking network to the n-th multi-tasking network, thereby selecting an optimal multi-tasking network with a best performance.

3. The method of claim 1, wherein, at the step of (b), the learning device is configured to generate a labeled consistency loss by referring to a 1-st specific consistency loss to an n-th specific consistency loss, and then generate the total consistency loss by further referring to the labeled consistency loss,
wherein the 1-st specific consistency loss is generated by referring to the 1-st specific task result and each of 1-st other specific task results corresponding to the 1-st specific task result, and
wherein the n-th specific consistency loss is generated by referring to the n-th specific task result and each of n-th other specific task results corresponding to the n-th specific task result.

4. The method of claim 1, wherein the learning device is configured to generate a total network loss by adding the total task loss and the total consistency loss, and train the 1-st multi-tasking network to the n-th multi-tasking network by using the total network loss, wherein the total task loss and the total consistency loss are balanced by adjusting an application ratio of the total consistency loss through hyperparameters of the learning device.

5. The method of claim 1, wherein the 1-st multi-tasking network to the n-th multi-tasking network are generated by cloning an initial multi-tasking network configured to perform the n tasks.

6. The method of claim 1, wherein the learning device is configured to (i) generate a mini batch including at least one 1-st training data sampled from the 1-st sub dataset to at least one n-th training data sampled from the n-th sub dataset, (ii) for each of all training data included in the mini batch, wherein all the training data have been generated at the step of (b) after performing the step (a), (ii-1) generate a mini batch task loss by averaging each of total task losses on each of all the training data and (ii-2) generate a mini batch consistency loss by averaging each of total consistency losses on each of all the training data, and (iii) train the 1-st multi-tasking network to the n-th multi-tasking network by using the mini batch task loss and the mini batch consistency loss.

7. A method for testing a trained multi-tasking network by using each of datasets having each of task labels corresponding to each of different tasks, the method comprising:
(a) on condition that a learning device has performed processes of (i) in response to acquiring specific training data from a main dataset including a 1-st sub dataset having a 1-st task label to an n-th sub dataset having an n-th task label, wherein the n is an integer of 2 or more, inputting the specific training data into each of a 1-st multi-tasking network to an n-th multi-tasking network performing each of n tasks to thereby instruct each of the 1-st multi-tasking network to the n-th multi-tasking network to perform learning operation on the specific training data and thus to output each of n task results for training; and (ii) calculating a 1-st task loss to an n-th task loss by referring to each of a 1-st specific task result for training to an n-th specific task result for training of the 1-st multi-tasking network to the n-th multi-tasking network for a specific task corresponding to a specific task label included in the specific training data and the specific task label, calculating a 1-st unlabeled consistency loss group comprised of a (1_1)-st unlabeled consistency loss to a (1_m)-th unlabeled consistency loss to an n-th unlabeled consistency loss group comprised of a (n_1)-st unlabeled consistency loss to an (n_m)-th unlabeled consistency loss by referring to a (j_k)-th task result and an (x_k)-th task result, while increasing j from 1 to n, and while increasing k from 1 to m for each j, wherein m corresponds to remaining tasks other than the specific task among the n tasks, and wherein x corresponds to remaining multi-tasking networks other than any one multi-tasking network specified by j among the 1-st multi-tasking network to the n-th multi-tasking network, and (iii) training the 1-st multi-tasking network to the n-th multi-tasking network by using (iii-1) a total task loss generated by referring to the 1-st task loss to the n-th task loss and (iii-2) a total consistency loss generated by referring to the 1-st unlabeled consistency loss group comprised of the (1_1)-st unlabeled consistency loss to the (1_m)-th unlabeled consistency loss to the n-th unlabeled consistency loss group comprised of the (n_1)-st unlabeled consistency loss to the (n_m)-th unlabeled consistency loss, a testing device acquiring testing data without a task label; and
(b) the testing device (i) inputting the testing data to an optimal multi-tasking network having a best performance among the 1-st multi-tasking network to the n-th multi-tasking network, and (ii) instructing the optimal multi-tasking network to perform learning operation on the testing data, to thereby output n task results for testing.

8. The method of claim 7, wherein, at the step (a), the learning device has performed processes of (i) generating a mini batch including at least one 1-st training data sampled from the 1-st sub dataset to at least one n-th training data sampled from the n-th sub dataset, (ii) for each of all training data included in the mini batch, wherein all the training data have been generated at the process of (ii) after performing the process of (i), (ii-1) generating a mini batch task loss by averaging each of total task losses on each of all the training data generated in (ii) above, and (ii-2) generating a mini batch consistency loss by averaging each of total consistency losses on each of all the training data, and (iii) training the 1-st multi-tasking network to the n-th multi-tasking network by using the mini batch task loss and the mini batch consistency loss.

9. A learning device for training a multi-tasking network configured to perform multi-tasks by using each of datasets having each of task labels corresponding to each of different tasks, the learning device comprising:
a memory storing instructions for training the multi-tasking network configured to perform the multi-tasks by using each of the datasets having each of the task labels corresponding to each of the different tasks; and
a processor performing operations for training the multi-tasking network configured to perform the multi-tasks by using each of the datasets having each of the task labels corresponding to each of the different tasks according to the instructions stored in the memory;
wherein the processor performs (I) a process of, in response to acquiring specific training data from a main dataset including a 1-st sub dataset having a 1-st task label to an n-th sub dataset having an n-th task label, wherein the n is an integer of 2 or more, inputting the specific training data into each of a 1-st multi-tasking network to an n-th multi-tasking network performing each of n tasks, to thereby instruct each of the 1-st multi-tasking network to the n-th multi-tasking network to perform learning operation on the specific training data and thus to output each of n task results; and (II) processes of (II-1) calculating a 1-st task loss to an n-th task loss by referring to a specific task label and each of a 1-st specific task result to an n-th specific task result of the 1-st multi-tasking network to the n-th multi-tasking network for a specific task corresponding to the specific task label included in the specific training data, (II-2) calculating a 1-st unlabeled consistency loss group comprised of a (1_1)-st unlabeled consistency loss to a (1_m)-th unlabeled consistency loss to an n-th unlabeled consistency loss group comprised of a (n_1)-st unlabeled consistency loss to an (n_m)-th unlabeled consistency loss by referring to a (j_k)-th task result and an (x_k)-th task result, while increasing j from 1 to n, and while increasing k from 1 to m for each j, wherein m corresponds to remaining tasks other than the specific task among the n tasks, and wherein x corresponds to remaining multi-tasking networks other than any one multi-tasking network specified by j among the 1-st multi-tasking network to the n-th multi-tasking network, and (II-3) training the 1-st multi-tasking network to the n-th multi-tasking network by using (II-3-a) a total task loss generated by referring to the 1-st task loss to the n-th task loss and (II-3-b) a total consistency loss generated by referring to the 1-st unlabeled consistency loss group comprised of the (1_1)-st unlabeled consistency loss to the (1_m)-th unlabeled consistency loss to the n-th unlabeled consistency loss group comprised of the (n_1)-st unlabeled consistency loss to the (n_m)-th unlabeled consistency loss.

10. The learning device of claim 9, wherein the processor further performs (III) the learning device assessing performances of the 1-st multi-tasking network to the n-th multi-tasking network, thereby selecting an optimal multi-tasking network with a best performance.

11. The learning device of claim 9, wherein the processor, at the process of (II), is configured to generate a labeled consistency loss by referring to a 1-st specific consistency loss to an n-th specific consistency loss, and generate the total consistency loss by further referring to the labeled consistency loss,
wherein the 1-st specific consistency loss is generated by referring to the 1-st specific task result and each of 1-st other specific task results corresponding to the 1-st specific task result, and
wherein the n-th specific consistency loss is generated by referring to the n-th specific task result and each of n-th other specific task results corresponding to the n-th specific task result.

12. The learning device of claim 9, wherein the processor is configured to generate a total network loss by adding the total task loss and the total consistency loss, and train the 1-st multi-tasking network to the n-th multi-tasking network by using the total network loss, wherein the total task loss and the total consistency loss are balanced by adjusting an application ratio of the total consistency loss through hyperparameters of the learning device.

13. The learning device of claim 9, wherein the 1-st multi-tasking network to the n-th multi-tasking network are generated by cloning an initial multi-tasking network configured to perform the n tasks.

14. The learning device of claim 9, wherein the processor is configured to (i) generate a mini batch including at least one 1-st training data sampled from the 1-st sub dataset to at least one n-th training data sampled from the n-th sub dataset, (ii) for each of all training data included in the mini batch, wherein all the training data have been generated at the step of (b) after performing the step (a), (ii-1) generate a mini batch task loss by averaging each of total task losses on each of all the training data and (ii-2) generate a mini batch consistency loss by averaging each of total consistency losses on each of all the training data, and (iii) train the 1-st multi-tasking network to the n-th multi-tasking network by using the mini batch task loss and the mini batch consistency loss.

15. A testing device for testing a trained multi-tasking network by using each of datasets having each of task labels corresponding to each of different tasks, the testing device comprising:
a memory storing instructions for testing the trained multi-tasking network by using each of the datasets having each of the task labels corresponding to each of the different tasks; and
a processor performing operations for testing the trained multi-tasking network by using each of the datasets having each of the task labels corresponding to each of the different tasks according to the instructions stored in the memory;
wherein the processor performs (I) on condition that a learning device, has performed processes of (i) in response to acquiring specific training data from a main dataset including a 1-st sub dataset having a 1-st task label to an n-th sub dataset having an n-th task label, wherein the n is an integer of 2 or more, inputting the specific training data into each of a 1-st multi-tasking network to an n-th multi-tasking network performing each of n tasks to thereby instruct each of the 1-st multi-tasking network to the n-th multi-tasking network to perform learning operation on the specific training data and thus to output each of n task results for training; and (ii) calculating a 1-st task loss to an n-th task loss by referring to each of a 1-st specific task result for training to an n-th specific task result for training of the 1-st multi-tasking network to the n-th multi-tasking network for a specific task corresponding to a specific task label included in the specific training data and the specific task label, calculating a 1-st unlabeled consistency loss group comprised of a (1_1)-st unlabeled consistency loss to a (1_m)-th unlabeled consistency loss to an n-th unlabeled consistency loss group comprised of a (n_1)-st unlabeled consistency loss to an (n_m)-th unlabeled consistency loss by referring to a (j_k)-th task result and an (x_k)-th task result, while increasing j from 1 to n, and while increasing k from 1 to m for each j, wherein m corresponds to remaining tasks other than the specific task among the n tasks, and wherein x corresponds to remaining multi-tasking networks other than any one multi-tasking network specified by j among the 1-st multi-tasking network to the n-th multi-tasking network, and (iii) training the 1-st multi-tasking network to the n-th multi-tasking network by using (iii-1) a total task loss generated by referring to the 1-st task loss to the n-th task loss and (iii-2) a total consistency loss generated by referring to the 1-st unlabeled consistency loss group comprised of the (1_1)-st unlabeled consistency loss to the (1_m)-th unlabeled consistency loss to the n-th unlabeled consistency loss group comprised of the (n_1)-st unlabeled consistency loss to the (n_m)-th unlabeled consistency loss, a testing device acquiring testing data without a task label; and
(II) the testing device (i) inputting the testing data to an optimal multi-tasking network having a best performance among the 1-st multi-tasking network to the n-th multi-tasking network, and (ii) instructing the optimal multi-tasking network to perform learning operation on the testing data, to thereby output n task results for testing.

16. The testing device of claim 15, wherein, at the process (I), the learning device has performed processes of (i) generating a mini batch including at least one 1-st training data sampled from the 1-st sub dataset to at least one n-th training data sampled from the n-th sub dataset, (ii) for each of all training data included in the mini batch, wherein all the training data have been generated at the process of (II) after performing (i), (ii-1) generating a mini batch task loss by averaging each of total task losses on each of all the training data generated in (ii) above, and (ii-2) generating a mini batch consistency loss by averaging each of total consistency losses on each of all the training data, and (iii) training the 1-st multi-tasking network to the n-th multi-tasking network by using the mini batch task loss and the mini batch consistency loss.
